(19) United States
(12) Patent Application Publication
(10) Pub. No.: US 2025/0098691 A1
(43) Pub. Date: Mar. 27, 2025

(54) POULTRY FEET STERILIZER

(71) Applicant: John Bean Technologies Corporation, Chicago, IL (US)

(72) Inventor: Dustin Adam Huggins, Russellville, AR (US)

(73) Assignee: John Bean Technologies Corporation, Chicago, IL (US)

(21) Appl. No.: 18/472,940

(22) Filed: Sep. 22, 2023

(51) Int. Cl. A23B 4/005; A22B 5/00; A22C 21/00; A23B 4/26; B01D 29/01; B01D 35/30; B65G 33/14; C02F 1/00; C02F 103/22

(52) U.S. Cl. CPC A23B 4/0053; A22B 5/0082; A22C 21/0061; A23B 4/26; B01D 29/01; B01D 35/30; B65G 33/14; C02F 1/001; B01D 2201/48; B65G 2201/047; C02F 2103/22

(57) ABSTRACT

The sanitizer includes an elongated semi-cylindrical tank that houses heated process water and a close-fitting auger to move food products from the inlet end of the tank to the outlet end. Heated process water at a temperature sufficient to sanitize the food product is introduced into the tank at the outlet end of the tank to flow through the tank counter to the direction of flow of the food product. A recirculation and filter system filters out the particulates in the process water. A hood assembly is positioned over the tank to contain the air borne moisture generated during the sanitizing process and route the steam away from the tank. A control system controls the operation of the sanitizer, including, for example, the speed of the auger, the volume of process water in the tank, and the temperature of the process water in the tank.

### BACKGROUND

Poultry feet, including chicken feet, are harvested during poultry processing. The feet are a favorite food item in many Asian countries, including in China, Korea, the Philippines, and Vietnam. Accordingly, harvest poultry feet have been exported from poultry producing countries to Asian countries.

However, a problem that has arisen is the presence of avian flu virus on harvested poultry feet. It is not possible to ship poultry feet to Asian countries if the avian flu virus is present. The disclosed system and method seek to eradicate the avian flu virus from harvested poultry feet.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an auger type food product sanitizer is provided. The auger type food product includes a semicircular, elongated tank having an open top, a closed inlet end, and a closed outlet end, an auger mounted for rotation in the tank, the auger comprising a helical blade defining at least one flight forming a helical path with the tank from the inlet end to the outlet end of the tank to move the food product along the helical path from the inlet end to the outlet end of the tank, a volume of process water in the tank, the process water introduced into the outlet end of the tank to flow toward the inlet end of the tank, a filter assembly receiving the process water from the tank to remove particulates from the process water, a heating system heating the filtered process water to at least 170 degrees Fahrenheit for reintroduction into the outlet end of the tank, and a hood positioned over the open top of the tank to close off the open top of the tank, the hood defining at least one outlet for expelling steam from the tank.

In any of the embodiments described herein, wherein the filter assembly receives the process water from the inlet end of the tank.

In any of the embodiments described herein, wherein the filter assembly includes a housing located exterior of the tank and in process water flow communication with the tank, a porous partition located between the tank and the housing through which the process water flows to enter the housing, partition preventing the food product to pass into the housing, a filter spaced from the partition through which the process water flows, and an overflow outlet in communication with the housing to receive the process water from the housing and direct the process water away from the tank.

In any of the embodiments described herein, wherein the process water received by the overflow outlet bypasses the filter, but not the partition.

In any of the embodiments described herein, wherein the filter is located within the housing.

In any of the embodiments described herein, wherein the filter is located exterior to the housing.

In any of the embodiments described herein, wherein the process water is heated to a temperature selected from the range of: 170 degrees Fahrenheit to 185 degrees Fahrenheit; and 175 degrees Fahrenheit to 180 degrees Fahrenheit.

In any of the embodiments described herein, wherein the hood includes a plurality of doors that are openable to provide access to the tank.

In any of the embodiments described herein, wherein the heating system is selected from the group selected from: (i) a heat exchanger through which the process water is circulated, the heat exchanger receiving steam from a source of steam for injection into the process water in the heat exchanger to heat the process water; (ii) a heat exchanger through which the process water is circulated, the heat exchanger comprising heating tubes through which a heated fluid is routed, the process water being heated by contact with the heating tubes; and (iii) a remote tank receiving the filtered process water for mixing with the process water in the remote tank and a heater heating the process water in the remote tank.

In any of the embodiments described herein, further comprising a control system for controlling the operation of the sanitizer, including the auger, the flow of process water into the tank, and the heating system.

In accordance with another embodiment of the present invention, an auger type food product sanitizer is provided. The auger type food product sanitizer includes a semicircular, elongated heating tank having an open top, a closed inlet end, and a closed outlet end, the tank holding a volume of process water to sanitize the food product, an auger mounted for rotation in the tank, the auger comprising a helical blade defining at least one flight forming a helical path with the tank for the food product to travel from the inlet end to the outlet end of the tank, a filter assembly receiving the process water from the tank to remove particulates from the process water, a heat exchanger receiving the process water from the filter assembly, the heat exchanger heating water to at least 170 degrees Fahrenheit for reintroduction into the tank, a transfer line for routing the process water from the heat exchanger to the tank, and a hood positioned over the open top of the tank to cover the open top of the tank, the hood defining at least one outlet for expelling steam from the tank.

In any of the embodiments described herein, wherein the filter assembly receives the process water from the inlet end of the tank.

In any of the embodiments described herein, wherein the filter assembly includes a housing located exterior of the tank and in process water flow communication with the tank, a partition located between the tank and the housing, the partition having openings sized to allow the process water to flow into the housing, but preventing the food product to pass into the housing, a filter spaced from the partition through which the process water flows, and an overflow outlet in communication with the housing to receive the process water from the housing and direct the process water away from the tank.

In any of the embodiments described herein, wherein the process water is received by the overflow outlet bypasses the filter, but not the partition.

In any of the embodiments described herein, wherein the filter is positioned at a location selected from: within the housing and exterior to the housing.

In any of the embodiments described herein, wherein the process water is heated to a temperature range of: 170 degrees Fahrenheit to 185 degrees Fahrenheit; and 175 degrees Fahrenheit to 180 degrees Fahrenheit.

In any of the embodiments described herein, wherein the hood includes a plurality of doors that are openable to provide access to the tank.

In any of the embodiments described herein, wherein the heat exchanger receives steam from a source of steam to heat the process water.

In any of the embodiments described herein, further comprises an injector for injecting the seam directly into the process water in the heat exchanger.

In any of the embodiments described herein, further comprising a controller for controlling the operation of the food product sanitizer, including the auger and the heat exchanger.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of the sanitizing system of the present disclosure;

FIG. 2 is an isometric view of the sanitizing system of FIG. 1 taken from the opposite side from FIG. 1;

FIG. 3 is an isometric view of the same side of the sanitizing system as shown in FIG. 2, with the hood in open position and certain components broken away;

FIG. 4 is a cross-sectional view of FIG. 1, taken along lines 4-4 thereof;

FIG. 5 is a cross-sectional view of the FIG. 1, taken along lines 5-5 thereof;

FIG. 6 is cross-sectional view of FIG. 1, taken along lines 6-6 thereof;

FIG. 7 is an isometric view of the hood assembly of the sanitizing system;

FIG. 8 is an enlarged fragmentary isometric view of the recirculation tank of the sanitizing system;

FIG. 9 is schematic view of a system for heating the process water used in the sanitizing system;

FIG. 10 is a schematic view of another system for heating the process water used in the sanitizing system.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about”, or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the following description, various embodiments of the present disclosure are described. In the following description and in the accompanying drawings, the corresponding systems assemblies, apparatus and units may be identified by the same part number, but with an alpha suffix. The descriptions of the parts/components of such systems assemblies, apparatus, and units that are the same or similar are not repeated so as to avoid redundancy in the present application.

In the present application and claims, references to “food product” are meant to include all manner of foods, including, but not limited to, poultry feet or paws, and including, but not limited to, chicken and turkey feet or paws.

The figures depict an auger-type sanitizer 100 of the present disclosure. The sanitizer 100 includes an elongated semi-cylindrical tank 102 that houses heated process water and a close-fitting, multiple blade auger 104 that is mounted within the tank to rotate about a longitudinal axis 106 corresponding to the diametrical center of the tank. The auger 104 can be powered for rotation by a standard known manner in the art to move food products from the inlet end 108 of the tank 102 to the outlet end 110. Heated process water at a temperature sufficient to sanitize the food product is introduced into the tank 102 at the outlet end 110 of the tank to flow through the tank counter to the direction of flow of the food product. The process water is heated in a heating system 112 external to the tank 102. A recirculation and filter system 114 filters out the particulates in the process water from the inlet end 108 of the tank 102 before the filtered water is routed to the heating system 112. A hood assembly 116 is positioned over the tank 102 to contain the air borne moisture, including steam, generated during the sanitizing process and route the steam away from the tank and the area around the tank. A control system 118 controls the operation of the sanitizer 100, including, for example, the speed of the auger 104, the volume of process water in the tank 102, and the temperature of the process water in the tank 102. It is to be understood that the sanitizer 100 need not be constructed or provided with all of the foregoing components, rather one or more of the foregoing components may be omitted or optional.

Describing the construction and operation of the sanitizer 100 in more detail, the tank 102 includes an auger or loading section 102A and an unloading section 102B. The auger or heating section 102A constitutes the majority of the length of the tank, whereas the unloader section 102B occupies a relatively short section at the outlet end 110 of the tank.

The tank 102 includes a semicircular shell 120 with the axis 106 corresponding to the diametrical center of the shell. Circumferentially the shell 120 that extends well above the level of the axis 106, thereby increasing the working volume of the tank 102 over many existing auger tank designs wherein the water level is limited to the rotational axis of the auger. As a non-limiting example, the shell 120 can extend from about 236 degrees to about 270 degrees of a full circle.

An inlet end wall 124 closes off the inlet end of the tank 102, and an outlet end wall 126 closes off the outlet end of the tank. A reinforcing ring 130 can be employed to extend semi-circularly around the exterior of the shell at a location centrally along the length of the shell. Feet, not visible, can be formed near the bottoms of the end walls 124 and 126 and the reinforcing ring 130 to support the sanitizer on a floor or similar surface. Longitudinal bars 132 extend along the upper edges of the tank shell to define the upper opening 134 of the tank 102.

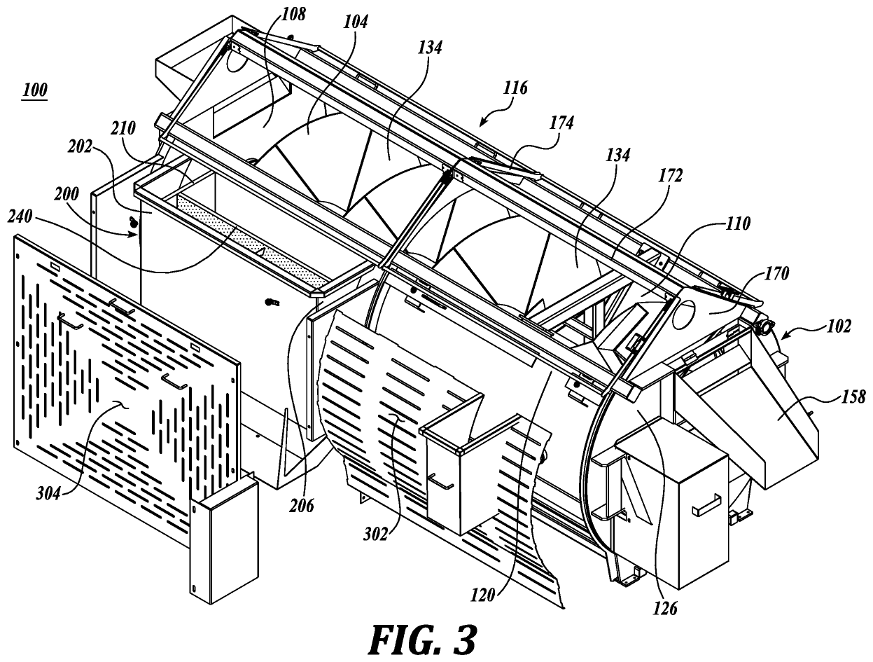

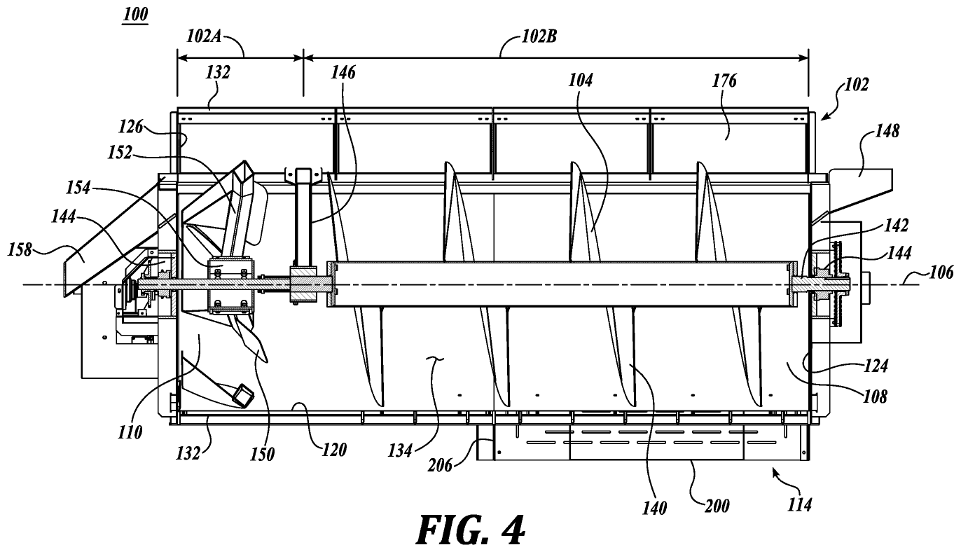

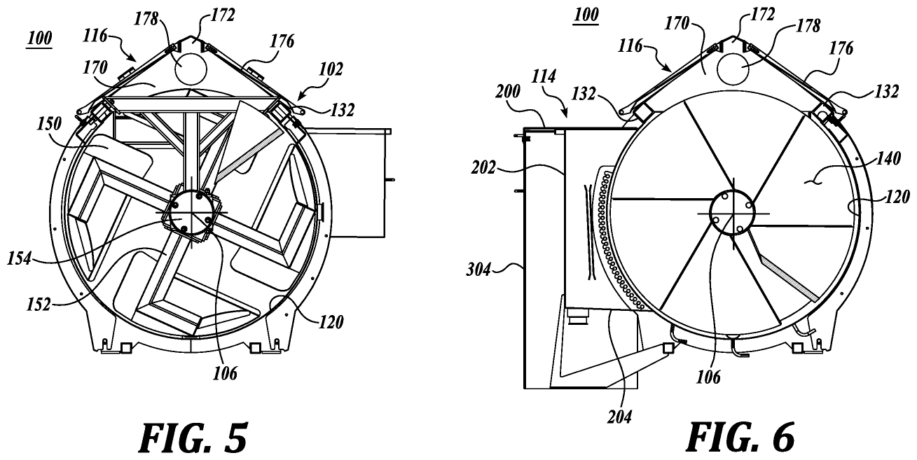

Auger 104 is composed of multiple blades 140 that are secured to and evenly spaced along a powered auger shaft 142. The shaft 142 extends along the longitudinal center 106 of the tank 102. The ends of the auger shaft 142 at the tank inlet end 108 and outlet end 110 are also supported by a bearing assembly 144 and a bearing hanger structure 146 is provided to support the shaft at the intersection heating section 102A and the unloading section 102B of the tank. The outer edges of the blades sweep closely along and around the inside surface of the tank shell 120. Also, the tops of the blades 140, as shown in FIG. 3, extend above the top opening 134 of the tank 102.

The food products are introduced into the tank 102 and the inlet end 108 via an inlet trough 148 projecting longitudinally from the inlet wall 124. The trough receives the food products from a delivery source not shown. The delivery source can be a delivery tube, a delivery conveyor, or other type of delivery structure or system.

As noted above, the tank 102 includes an unloader section 102B. The purpose of the unloaded section is to remove the sanitized food products for further processing. To this end, a series of unloader paddles 150 are mounted on the ends of arms 152 that extend radially from a central hub 154 that is rotated about axis 106 by the auger shaft 142.

The paddles 150 are shaped to scoop up the food products that have arrived at the unloader section 102B as the paddles sweep closely along the insider surface of the shell 120 of the unloader section and adjacent an end wall 126 that closes off the end of the tank 102. The paddles 150 lift the food products to the top of the unloader section, during which travel the food products are held captive by the paddles and an end wall 126. Once at the top of the unloader section 102B, the food products drop by gravity out an opening 156 formed at the top of an end wall 126 and down a sloped trough 158 into a receptacle or on to a takeaway conveyor, not shown, for further processing.

As noted above, the hood assembly 116 is positioned over the tank 102 to contain the steam generated during the sanitizing process and route to seam away from the tank and the area around the tank. In this regard, the hood assembly covers the top opening 134 of the tank, while also allowing access to the tank opening.

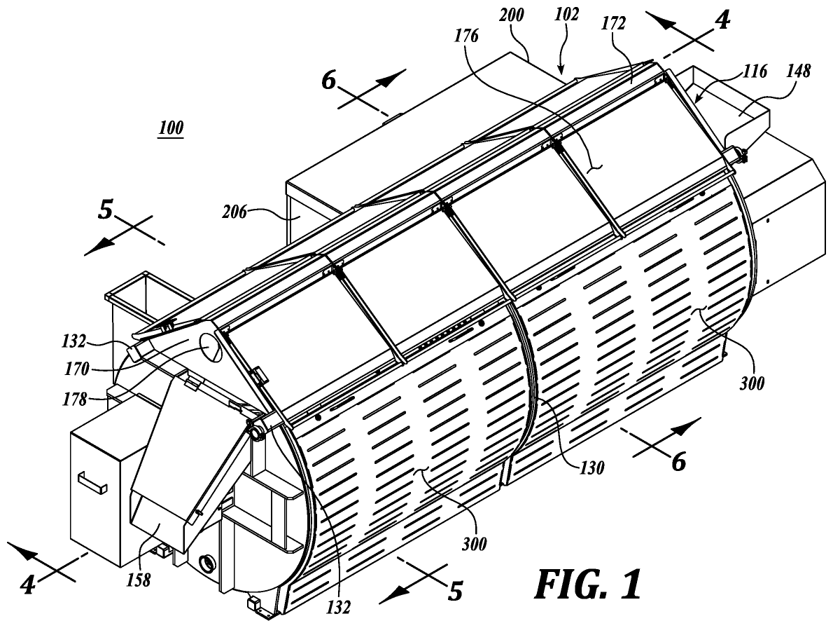

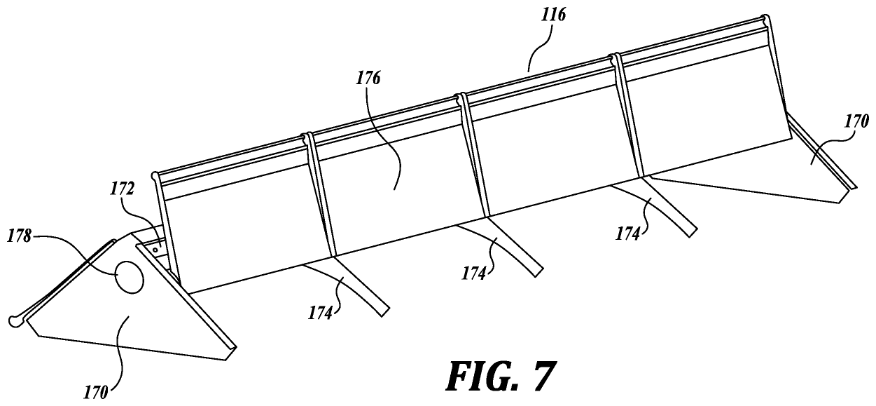

Referring to FIGS. 1-3 and 7, the hood assembly include triangular or peaked end walls 170 and a ridge beam structure 172 that spans the length of the hood assembly. The bottom edges of the end walls 170 rest on the upper edges of the ends of the tank 102. The ends of the ridge beam are attached to the upper apex of the end walls 170.

A series of intermediate support members 174 span transversely across the tank 102 to support the ridge beam structure 172. The ends of the support members 174 rest on the longitudinal bars 132 that extend along the upper side edges of the tank opening 134.

A plurality of access doors 176 form the sloped roof structure of the hood assembly 116. The doors extend either from an end wall 170 to the nearest support member 174 or extend between adjacent support members. Although not necessary, the end walls 170 and the support members could be used to support the side edges of the doors and/or help seal the side edges of the doors.

The upper edges of the doors are hinged to the ridge beam structure 172. The lower edges of the doors rest on the side edges of the tank opening 134 and extend a distance beyond the opening edges so as to be conveniently manually graspable for lifting the doors upwardly into open position. As can be appreciated, the construction of the hood assembly 116 prevents the escape of steam or other moisture from the tank 102, while providing convenient access to the interior to the tank for inspection, maintenance, repair and cleaning.

Openings 178 are provided in the hood end walls 170 for connecting an exhaust tube or pipe, not shown, to draw the steam and moisture away from the tank 102, and route the steam/moisture into the atmosphere or other location.

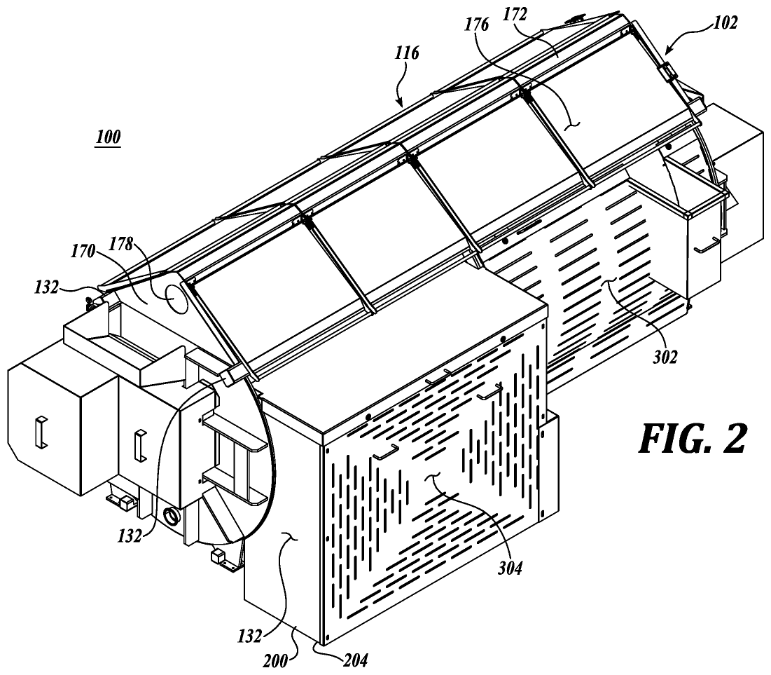

Next referring to FIGS. 2, 3 and 8, the recirculation and filter system includes a generally rectilinearly-shaped recirculation tank or housing 200 that is mounted to the side of the tank 102 adjacent to inlet end of the tank. The recirculation housing 200 includes a planar side panel 202 spaced from the side wall of the housing 102 to define an interior volume. The housing 200 also includes a planar bottom panel 204 and planar end panels 206, which also serve to form the housing 200. Of course, the panels 202, 204, and 206 do not have to be planar, but could be curved or otherwise shaped.

The section of the tank 102 located at the housing 200 is open to the tank 102 to allow the heated water to flow from tank 102 into the housing 200. A porous partition 210 divides the housing 200 from the tank 102. The partition 210 allows the heated process water to pass into the housing 200, but not the food product.

In one exemplary form, the partition 210 can be composed of a series of vertically space apart horizontal bars 212 extending along an opening formed in the wall of tank 102. In a more specific, but exemplary example, the bars 212 can be round in cross-section to reduce the drag force imposed on the partition by the flowing water relative to the drag created if the partition were constructed from bars of other shapes or constructed from other materials such as a perforated or expanded metal grating.

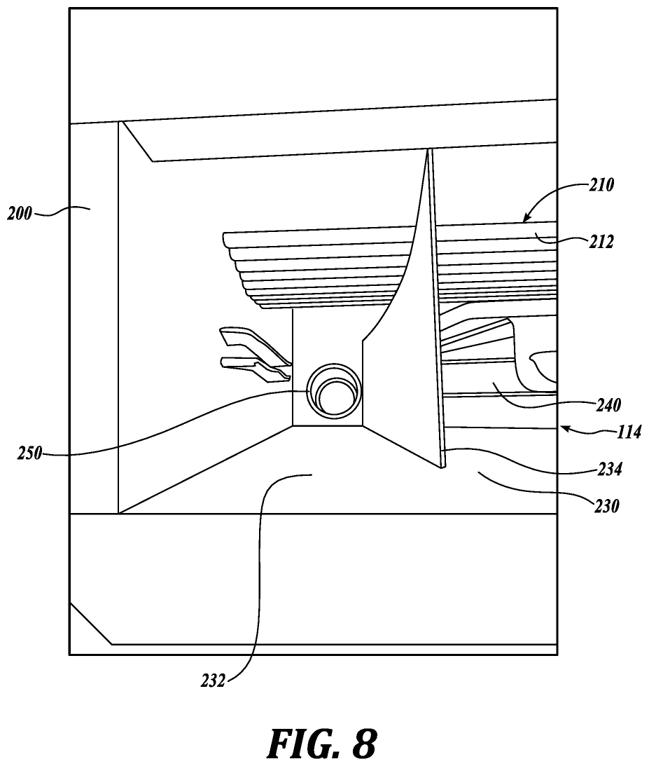

Referring to FIG. 8, the recirculation housing 200 is divided into two chambers, a larger filter chamber 230 and a smaller drain chamber 232 by a wall 234 extending laterally across the width of the housing. The process water passing through the partition flows into both chambers 230 and 232.

The process water that flows into chamber 230 passes through a filter 240 to capture the particulates from the food product. If the food product is composed of poultry feet, the particulates are composed of the skin or cuticles from the poultry feet.

The filter 240 can take different forms. For example, the filter can be in the form of a flat screen composed of a wire mesh or a perforated sheet that is mounted on a perimeter frame to provide structural integrity and stiffness to the filter. Further, the perforations can be in the form of holes of various shapes, slots, or a combination of holes and slots. The gauge of the wire mesh and the sizes of the perforations can be selected to allow the passage of the process water, but not the particulates desired to be removed from the process water.

The process water that flows past the filter 240 is routed to the heating system 112 to be heated to at least 170 degrees Fahrenheit and then introduced back into the tank 102 at the tank outlet end. The process water flows through the tank 102 counter to the direction of travel of the food product through the tank A standpipe 250 is positioned vertically or at least in upright orientation in the chamber 232. The lower end of the standpipe is connected to a drain to route the used process water entering the top of the pipe, to the facility's water treatment system. Such system typically includes a treatment stage that separates solids from the effluent and then filters the remaining liquid for reuse or disposal.

It will be appreciated that the level of process water in the tank 102 is controlled by the elevation of the upper end of the standpipe 250. Thus, raising or lowering the elevation of the upper end of the standpipe will correspondingly raise and lower the level of the process water in the tank 102. Applicant has also found that a significant proportion of the particulates from the tank 102 flow with the process water that enters the upper end of the standpipe 250, thereby reducing the load on the filter 240. As a result, the filter does not need to be cleaned as often as when all of the process water flowing into the tank 200 flows through the filter 240.

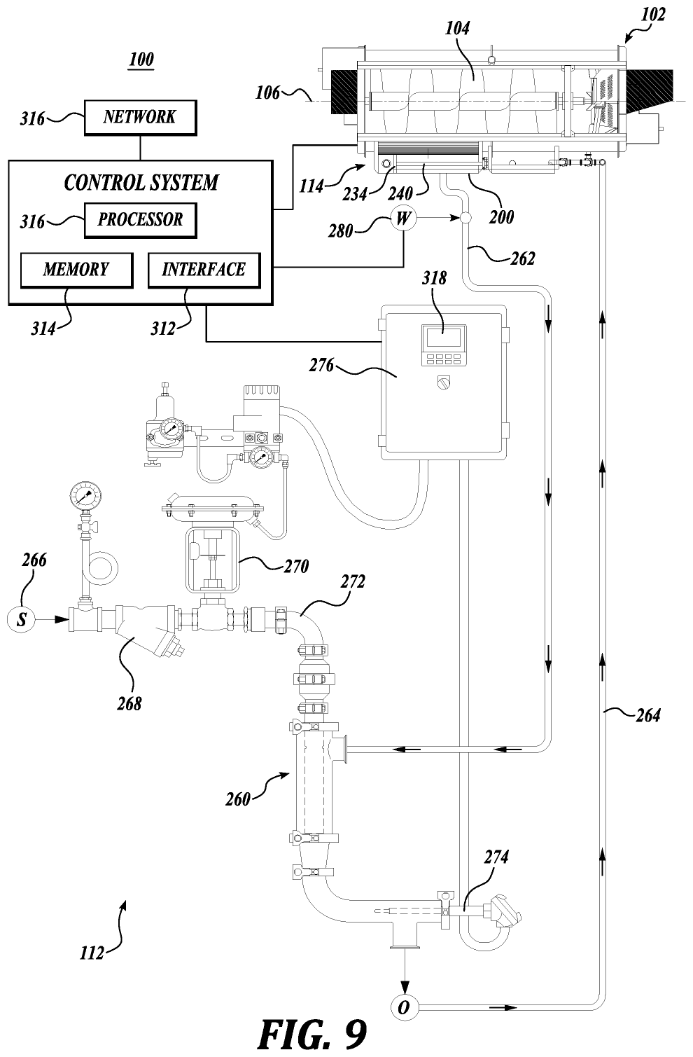

FIG. 9 schematically depicts one non-limiting example of the heating system 112. As shown in FIG. 9, the heating system 112 includes a heat exchanger 260 that receives filtered process water from the recirculation/filter system 114 via line 262. The process water heated by the heat exchanger is routed back to the tank outlet end 110 via line 264.

As one example, the water in the heat exchanger 260 is heated by direct injection of steam from a steam source 266. The steam flows through a check valve 268 and then through a flow control valve 270 that controls the volume of steam that enters the heat exchanger 260 by inline line 272. The steam is introduced directly into the heat exchanger 260 to heat the process water flowing through the heat exchanger.

A probe or other type of sensor 274 measures the temperature of the water leaving the heat exchanger 260, and sends an electronic signal to that effect to a control unit 276. The control unit controls the valve 270 to allow more or less steam to enter the heat exchanger 260 as needed.

Make-up water from a source 280 is fed into line 262 to replenish process water that is lost during the operation of the sanitizer system 100. Process water is lost due to several reasons, including evaporation from the tank 102 and being on the surface of the food product that is removed from the unloader section of the tank 102B.

The process water flowing through the heat exchanger 260 can be heated by other means other than direct injection. For example, the heat exchanger can be of the shell and tube type, where very hot water or steam is forced through tubes located within the interior of the heat exchanger shell. The process water to be heat is circulated around the heating tubes. Such shell and tube heat exchangers are articles of commerce.

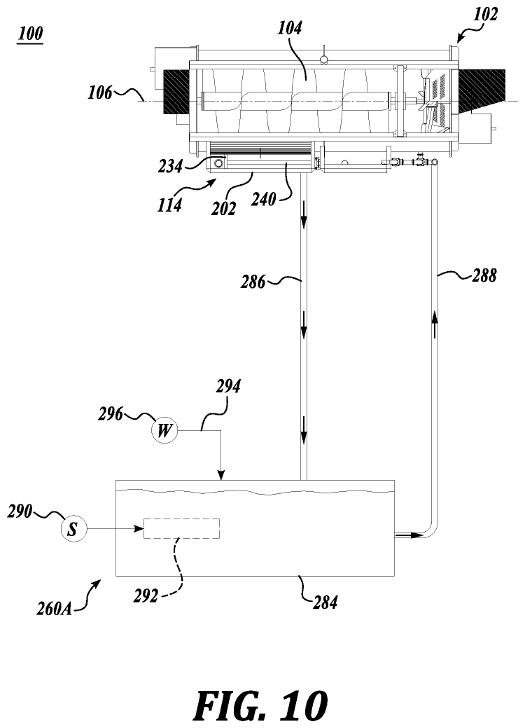

Rather than using a heat exchanger, the process water can be heated in a standalone tank 284, as shown in FIG. 10. The filtered process water from the recirculation/filter system 114 is sent to the tank 284 via line 286. The process water heated in the tank 284 is router back to the outlet end 110 of the auger tank 102 via line 288.

The process water in the tank 284 can be heated by various means. For example, steam from a steam supply 290 can be routed to an injector 292 located within the tank 284. Or a steam or hot water boiler can be used to heat the process water in the tank 284. Such boilers are articles of commerce.

Make-up water can be added to the tank 284 via an inlet line 294 connected to a water source 296.

Protective grills or guards are positioned about the tank 102, to prevent personnel from coming into direct contact with the tank 102 due to the high temperature of the process water, which, as noted above, can be at least 170 degrees Fahrenheit. As shown in FIGS. 1-3, curved grills 300 overlie the tank 102 on the side opposite the recirculation tank 200. Another curved grill 302 overlies that tank 102 to the side of the recirculation tank 200. Also a flat rectilinear grill 304 overlies the outward side panel 202 of the recirculation tank 200.

Each of the grills 300, 302, and 304 can be constructed in numerous ways. Nonetheless, typically the grills will be constructed with openings for the circulation of air through the grill. As needed, the grills can be designed to be conveniently removed for cleaning, maintenance, etc.

The control system 118 includes a processor or computer 310 and an interface 312 therefor for receiving signals and information from the heating system 112, as well as other data sources of system 100 that may be utilized. A memory unit 314 is provided for storing digital information regarding the control system 118. In addition to and/or in lieu of a local memory unit, the memory for the control system can be remotely located, for example, as part of a local or wide area network 316 or in the cloud. Transmission of data between the memory and the control system 118 can be by wired connection or by wireless connection.

An input/output device in the form of an HMI 318 is provided to enable an operator to communicate with the control system 118. The HMI 318 may include a touch screen that is mounted to a forward panel of the control unit 272 to convey information to and from the processing system, including the operational parameters of the processing apparatus 100 as well as the functioning of the apparatus, including the heating system 112. The control system 118 includes circuitry that functions to control the operation of the apparatus 10, including for example, the rotational speed of the auger 104, the heating system 112, the level of process water in the tank, etc. The control system 118 can be connected to the network 316. Also, rather than employing an on-board control system 118, a local or remote network computing system can be used for this purpose.

In operation, food products are introduced into the tank 102 via inlet trough 148. The food product is heated as the food product is moved along the tank 102 by the rotating auger 104. As noted above, the control system 118 controls the rotational speed of the auger and thus the dwell time of the food product in the tank 102.

The dwell time is selected so that the food product is heated to a desired temperature relative to the temperature of the process water in the tank. For example, if the food product consists of poultry feet, the temperature of the process water in the tank may be in the range of 170 degrees Fahrenheit to 185 degrees Fahrenheit, the desired dwell time in the tank 102 may be from about 6 to 6.5 minutes. This results in heating the poultry feet to at least 165 degrees Fahrenheit, which is a temperature sufficient to instantaneously kill a desired log level of the avian flu virus as well as other viruses and bacteria.

Alternatively, the temperature of the process water in the tank 102 may be high enough to kill the avian flu virus as well as other viruses and bacteria over a time duration. For example, the process water may be heated to 160 degree Fahrenheit for a length of time which is sufficient for a log 4 or a log 5 kill level of the avian flu virus as well as other viruses and bacteria

The control system 118 also controls the temperature of the process water heated in the heat heating system 112.

The control system 118 further controls the volume of heated process water introduced into the tank so that the level of the process water is maintained at a desired level in the tank 102.

While illustrative embodiments have been illustrated and described, it will be appreciated that various changes can be made therein without departing from the spirit and scope of the invention.

1. An auger type food product sanitizer, comprising:
a semicircular, elongated tank having an open top, a closed inlet end, and a closed outlet end;
an auger mounted for rotation in the tank, the auger comprising a helical blade defining at least one flight forming a helical path with the tank from the inlet end to the outlet end of the tank to move the food product along the helical path from the inlet end to the outlet end of the tank;
a volume of process water in the tank, the process water introduced into the outlet end of the tank to flow toward the inlet end of the tank;
a filter assembly receiving the process water from the tank to remove particulates from the process water;
a heating system heating the filtered process water to at least 170 degrees Fahrenheit for reintroduction into the outlet end of the tank; and
a hood positioned over the open top of the tank to close off the open top of the tank, the hood defining at least one outlet for expelling steam from the tank.

2. The sanitizer of claim 1, wherein the filter assembly receives the process water from the inlet end of the tank.

3. The sanitizer of claim 1, wherein the filter assembly, comprising:
a housing located exterior of the tank and in process water flow communication with the tank;
a porous partition located between the tank and the housing through which the process water flows to enter the housing, partition preventing the food product to pass into the housing;
a filter spaced from the partition through which the process water flows; and
an overflow outlet in communication with the housing to receive the process water from the housing and direct the process water away from the tank.

4. The sanitizer of claim 3, wherein the process water received by the overflow outlet bypasses the filter, but not the partition.

5. The sanitizer of claim 3, wherein the filter is located within the housing.

6. The sanitizer of claim 3, wherein the filter is located exterior to the housing.

7. The sanitizer of claim 1, wherein the process water is heated to a temperature selected from the range of: 170 degrees Fahrenheit to 185 degrees Fahrenheit; and 175 degrees Fahrenheit to 180 degrees Fahrenheit.

8. The sanitizer of claim 1, wherein the hood comprises a plurality of doors that are openable to provide access to the tank.

9. The sanitizer of claim 1, wherein the heating system is selected from the group selected from: (i) a heat exchanger through which the process water is circulated, the heat exchanger receiving steam from a source of steam for injection into the process water in the heat exchanger to heat the process water; (ii) a heat exchanger through which the process water is circulated, the heat exchanger comprising heating tubes through which a heated fluid is routed, the process water being heated by contact with the heating tubes; and (iii) a remote tank receiving the filtered process water for mixing with the process water in the remote tank and a heater heating the process water in the remote tank.

10. The sanitizer of claim 1, further comprising a control system for controlling the operation of the sanitizer, including the auger, the flow of process water into the tank, and the heating system.

11. An auger type food product sanitizer, comprising:
a semicircular, elongated heating tank having an open top, a closed inlet end, and a closed outlet end, the tank holding a volume of process water to sanitize the food product;
an auger mounted for rotation in the tank, the auger comprising a helical blade defining at least one flight forming a helical path with the tank for the food product to travel from the inlet end to the outlet end of the tank;
a filter assembly receiving the process water from the tank to remove particulates from the process water;
a heat exchanger receiving the process water from the filter assembly, the heat exchanger heating water to at least 170 degrees Fahrenheit for reintroduction into the tank;
a transfer line for routing the process water from the heat exchanger to the tank; and
a hood positioned over the open top of the tank to cover the open top of the tank, the hood defining at least one outlet for expelling steam from the tank.

12. The sanitizer of claim 11, wherein the filter assembly receives the process water from the inlet end of the tank.

13. The sanitizer of claim 11, wherein the filter assembly, comprising:
a housing located exterior of the tank and in process water flow communication with the tank;
a partition located between the tank and the housing, the partition having openings sized to allow the process water to flow into the housing, but preventing the food product to pass into the housing;
a filter spaced from the partition through which the process water flows; and
an overflow outlet in communication with the housing to receive the process water from the housing and direct the process water away from the tank.

14. The sanitizer of claim 13, wherein the process water received by the overflow outlet bypasses the filter, but not the partition.

15. The sanitizer of claim 3, wherein the filter is positioned at a location selected from: within the housing and exterior to the housing.

16. The sanitizer of claim 11, wherein the process water is heated to a temperature range of: 170 degrees Fahrenheit to 185 degrees Fahrenheit; and 175 degrees Fahrenheit to 180 degrees Fahrenheit.

17. The sanitizer of claim 11, wherein the hood comprises a plurality of doors that are openable to provide access to the tank.

18. The sanitizer of claim 11, wherein the heat exchanger receiving steam from a source of steam to heat the process water.

19. The sanitizer of claim 18, further comprising an injector for injecting the seam directly into the process water in the heat exchanger.

20. The sanitizer of claim 11, further comprising a controller for controlling the operation of the food product sanitizer, including the auger and the heat exchanger.
